(19) United States
(12) Patent Application Publication
(10) Pub. No.: US 2023/0302311 A1
(43) Pub. Date: Sep. 28, 2023

(54) Device for Rescuing a Person from a Wind Turbine, and a Wind Turbine

(71) Applicant: Paratec North America, Inc., NC Production Facility Office, Pinebluff, NC (US)

(72) Inventor: Stefan Ertler, Neunkirchen les Bouzonville (FR)

(21) Appl. No.: 18/124,598

(22) Filed: Mar. 22, 2023

(30) Foreign Application Priority Data
Mar. 24, 2022 (LU) 501703

(51) Int. Cl. A62B 35/00; B64D 17/00; A62B 1/00

(52) U.S. Cl. CPC A62B 35/0037; A62B 35/0018; B64D 17/00; A62B 1/00

(57) ABSTRACT

A device (1-1b) for rescuing a person (33) from a wind turbine (5), which comprises a parachute and a harness (9; 9b), which can be or is connected to the parachute, and which can be donned by the person to be rescued (33). Advantageously, a static line (2) is provided for connecting the rescue device (1-1b) to the wind turbine (5). Advantageously, rescuing maintenance personnel in an evacuation by jumping from the nacelle or an opening in the wind turbine is possible.

### CROSS REFERENCE TO RELATED APPLICATIONS

This application claims the priority of LU 501703 filed on 2022 Mar. 24; this application is incorporated by reference herein in its entirety.

### BACKGROUND

The invention relates to a device for rescuing a person from a wind turbine, which comprises a parachute and a harness, which can be or is connected to the parachute, and which can be donned by the person to be rescued. Furthermore, the invention relates to a wind turbine with such a rescue device and to the use of a parachute for the emergency rescue of a person from a wind turbine.

In wind turbines, components that need to be serviced regularly are usually located in the nacelle, i.e. in the engine enclosure. In case of an emergency, which could be a fire in the nacelle, for example, maintenance personnel must either go outside the nacelle to abseil down to the ground on rescue ropes or wait for helicopter-assisted rescue. If the fire spreads quickly, emergency responders often arrive too late or the rescue ropes burn up and the people abseiling fall to their death from a high altitude.

Due to the fact that modern wind turbines, whether onshore or offshore, are becoming more and more powerful, and thus larger and taller, new rescue options are required in order to be able to quickly evacuate maintenance personnel from the wind turbine in the event of an emergency, i.e. from the nacelle or from hollow rotor blades.

### SUMMARY

The invention relates to a device (1-1b) for rescuing a person (33) from a wind turbine (5), which comprises a parachute and a harness (9; 9b), which can be or is connected to the parachute, and which can be donned by the person to be rescued (33).

Advantageously, a static line (2) is provided for connecting the rescue device (1-1b) to the wind turbine (5). Advantageously, rescuing maintenance per-sonnel in an evacuation by jumping from the nacelle or an opening in the wind turbine is possible.

### DETAILED DESCRIPTION

The invention is based on the task of forming a device for rescuing a person from a wind turbine, by means of which a rapid emergency evacuation is made possible.

According to the invention, the task is solved in that a static line is provided for connecting the rescue device to the wind turbine.

Furthermore, the invention has the task of providing a device for rescuing a person from a wind turbine which is particularly easy to don.

In addition, the invention creates a wind turbine that enables a rapid emergency evacuation.

In that the rescue device according to the invention has a parachute, rescuing maintenance personnel in an evacuation by jumping from the nacelle or an opening in the wind turbine is possible. By means of the static line, through which the rescue device can be connected to the wind turbine and, when profes-sionally installed, is permanently connected, the parachute is opened without in-tervention by a user in the case of a jump, meaning that the rescue device ac-cording to the invention can already be used from jump heights of 70 m.

Ideally, a wind turbine will have as many rescue devices as maintenance person-nel can be tasked with maintenance at the same time.

Wind turbines are usually located in places where there is sufficient wind, meaning that the maintenance personnel using the rescue device are advantageously sus-pended on the parachute on the wind turbine and thus moved away from a dan-gerous area.

Advantageously, the harness comprises two leg straps and a preferably one-piece body strap, which can be connected to the two leg straps. One-piece means in particular that there are no connections such as seams that connect individual sec-tions of the strap together, but rather the body strap is formed from a single belt strap. It is advantageous if there are no possible break points.

The size of the leg straps that are placed around the thighs of the person using the rescue device in the circumferential direction cannot be altered, but the straps have an inner diameter suitable for different leg sizes. This is advantageous as people with legs of different thickness can use the device.

Furthermore, it is advantageous that the leg straps and the body strap form a har-ness, which a person to be rescued can put on easily.

In one embodiment of the invention, the harness comprises two leg straps, each of which has a loop, through which the preferably one-piece body strap is passed. The body strap is advantageously not firmly connected to the leg straps. This cre-ates a harness that can be adjusted to a person to be rescued.

In one embodiment of the invention, the harness can be adjusted to the body of the person to be rescued, in particular to their body shape and/or size. Advantageously, a customized rescue de-vice for each person performing maintenance to be rescued is not required, but rather a single, universally usable device, which can be permanently installed in the wind turbine.

Advantageously, the permanent installation also ensures that the static line can function as in-tended and that the parachute opens in an emergency in the event of a rescue by jumping out of the wind turbine.

In a further embodiment of the invention, the harness comprises two leg straps, which can be moved in the proximal direction to adjust the harness to the body of a person to be rescued, in par-ticular their height. In an initial position, in which the rescue device can be mounted in a wind tur-bine, the body strap is opened so wide that it can be put on by particularly large or muscular per-sons.

A harness, which has the two leg straps and a preferably one-piece body strap, can be put on by the person to be rescued stepping into the two leg straps, which are in particular not adjustable in size, and attaching the body strap, which is preferably one-piece, with the leg straps in such a way that the shoulder strap sections of the body strap rest on both shoulders. After putting on the har-ness, it is necessary to adjust it to the dimensions of the person to be rescued. Adjustment means a tightening of the body strap, which is preferably one-piece, in such a way that it is tight to the body of the person to be rescued. In this tightening, an effective length of the body strap, that is, a belt length that surrounds the body, is reduced such that the two leg straps are pulled up in the proximal direction, that is, in the direction of the upper body.

Advantageously, due to the ability to move the leg straps in a proximal direction, it is possible to adjust the device to the upper body length of the person to be rescued without needing the ability to change the size of the leg straps themselves.

Advantageously, the harness has a preferably one-piece body strap with two body strap sections, which intersect on a dorsal side. The body strap sections are arranged one on top of the other at the point at which they intersect and are preferably flush on one another. This crossed arrange-ment ensures a particularly good fixation of the person to be rescued in the harness after the har-ness is adjusted to their body.

In one embodiment of the invention, the harness has a preferably one-piece body strap, which is connected to the parachute at the point of intersection of two body strap sections of the body strap, which intersect on a dorsal side. A particularly stable connection is advantageously possible, in particular if a metal connecting means is used. It is further advantageous to ensure a stable rescue position, in which the person to be rescued can land on their feet. This prevents injuries.

Advantageously, the harness comprises a preferably one-piece body strap, the end sections of which can be moved to adjust the harness to the body of the per-son to be rescued, in particular their girth and their height, preferably in a direction that has a ventral and/or a lateral movement component. By moving the end sec-tions of the preferably one-piece body strap, an adjustment of the harness to the body of the person to be rescued is possible, since an effective strap length is shortened by moving the leg straps in the proximal direction such that the body strap is tight to the body of the person to be rescued. Advantageously, a rescue device is created, which can be completely adjusted to any body size and body shape only by pulling on two end sections.

In a further embodiment of the invention, the harness has a preferably one-piece body strap, which comprises a connecting means, through which the chest strap sections can be connected to and detached from each other. The connecting element may be designed as an adjustable buckle with a sliding element.

In one embodiment of the invention, the parachute is packed such that it is airtight and/or impermeable to liquid, preferably vacuum-packed. A packaging bag can be used for this. The parachute is protected from environmental influences such as moisture. A permanent installation in a wind turbine for several years without maintenance is advantageously possible.

In a further embodiment of the invention, the harness and/or a packaging bag, in which the parachute is located, is/are made of a fire-resistant or at least fire-retardant material. It is advantageous if it can be used in the event of a fire without sustaining damage; a fire-retardant design according to DIN 4102-2 is to be used.

A wind turbine according to the invention has a means, which is designed for the attachment of a static line to the rescue device. This can be an eyelet or a rail, on-to which, for example, the static line is permanently attached. Advantageously, the connecting means is located near an opening, through which the wind turbine can be exited after attaching the rescue device.

Due to the increasing size of the wind turbines, it is conceivable that rescue devic-es according to the invention are placed in hollow rotor blades of the wind turbine, so that during maintenance work in a rotor blade, it is possible to jump out of the blade in an emergency.

### BRIEF DESCRIPTION OF THE DRAWINGS

The invention is explained in more detail below using example embodiments and the accompanying drawings relating to the embodiments. The drawings show the following:

FIG. 1A wind turbine with a rescue device according to the invention,

FIG. 2 A top-down view of the rescue device according to the invention,

FIG. 3A Details for donning a rescue device according to the invention—body straps shown,

FIG. 3B Details for donning a rescue device according to the invention—pulling straps,

FIG. 3C Details for donning a rescue device according to the invention—buckling straps.

### DETAILED DESCRIPTION OF THE PREFERRED EMBODIMENTS

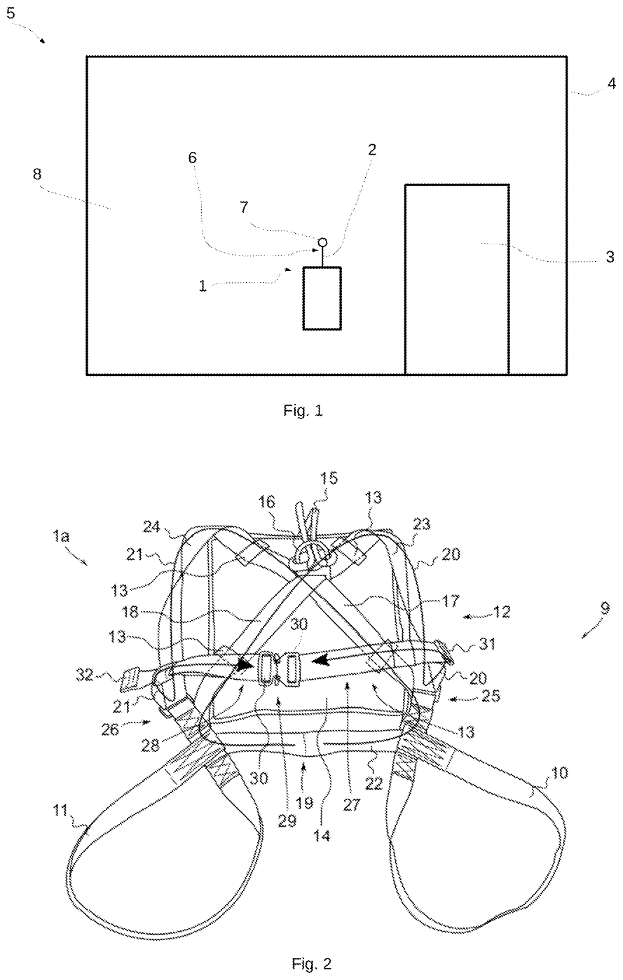

A rescue device 1 according to the invention, schematically shown in FIG. 1, com-prises a static line 2, through which a parachute, not shown in FIG. 1, can be pulled out in the case of a jump by a person wearing the rescue device 1 through an opening 3 in a nacelle 4 in a wind turbine 5, which is schematically shown in FIG. 1. For this purpose, one end 6 of the static line 2 facing the nacelle 4 is connected to a ring 7, which is attached to a wall 8 of the nacelle 4, for example by a carabiner.

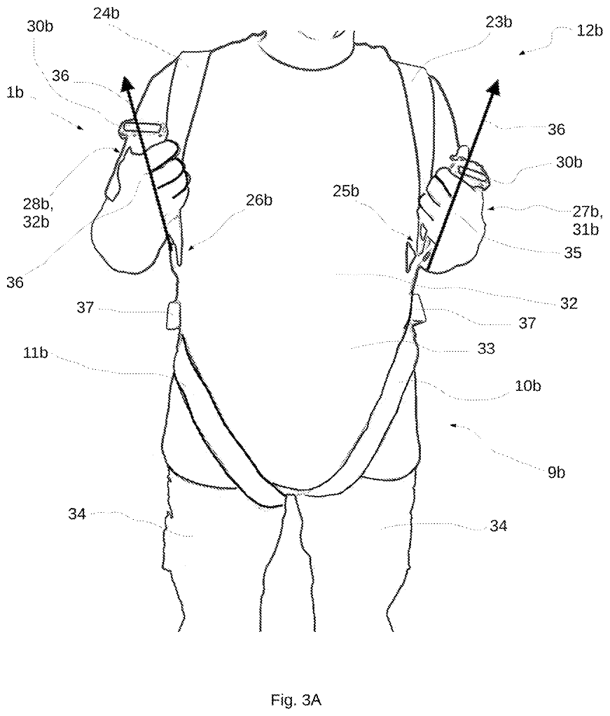

Reference is now made to FIG. 2, where identical parts or parts with the same ef-fect are designated with the same reference numbers as in FIG. 1 and the respec-tive reference number is accompanied by the letter a.

A rescue device 1a, schematically shown in FIG. 2, in a top-down view of a side facing the back of a person wearing the rescue device 1a comprises a harness 9, which has two leg straps 10, 11 and one body strap 12, which is a single piece in this example embodiment. The body strap 12 is connected by four loops 13 to a packing bag 14, in which a parachute is located. The parachute has a connecting line 15, which is connected to the body strap 12 by a formed and forged metal connecting element 16. Dorsal body strap sections 17, 18 cross at a point of inter-section formed by the connecting element 16. The connecting element 16 comprises in particular two eyelets, not shown in detail in FIG. 2, the first of which is intended for connecting to the connecting line 15 and the second of which is intended for connecting to the dorsal body strap sections 17, 18 of the body strap 12.

To better display the other elements, no static line is shown in FIG. 2.

The course of the one-piece body strap 12 around the body of a person wearing the rescue device 1a is explained below, starting from a centerline 19 placed on the body strap 12, which divides the body strap 12 into two equally large belt sec-tions, as well as two route lines marked with arrows 20 and 21.

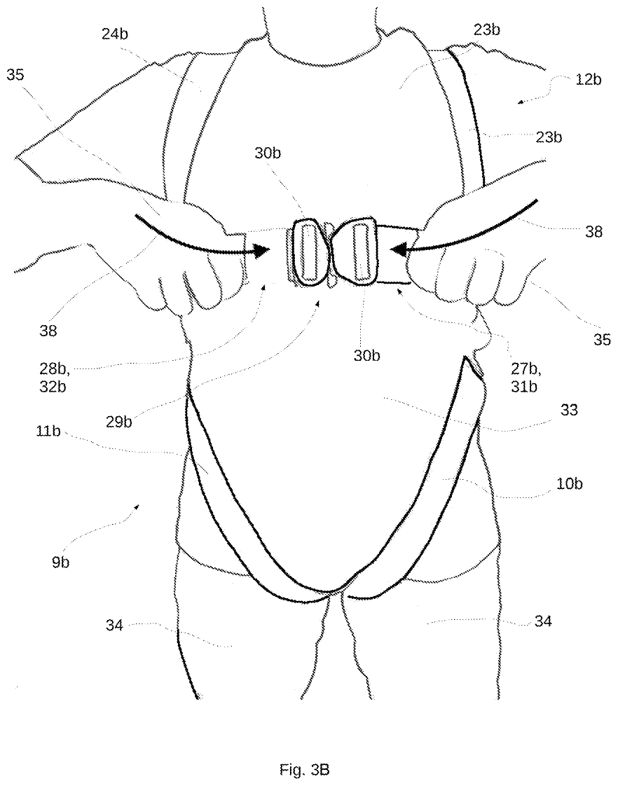

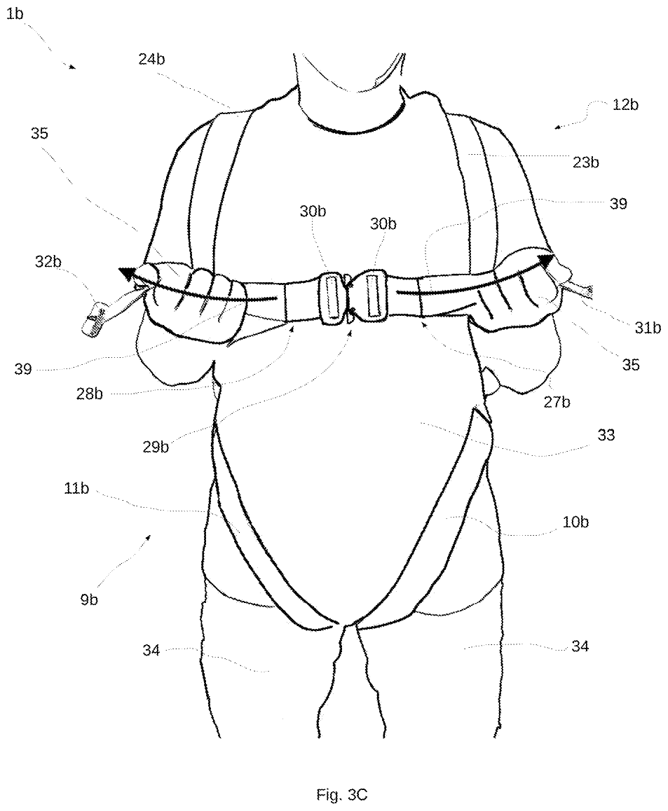

Starting from the centerline 19, a third dorsal belt section 22 extends on both sides of the centerline 19 in the direction of loops, not shown in FIG. 2 and marked in FIG. 3a as number 37, into the leg straps 10, 11, through which this third dorsal belt section 22 runs and leads into the two intersecting dorsal body strap sections 17, 18, which in turn, in the area of the connecting element 16, lead into two shoulder belt sections 23, 24 on both sides, which are each intended to wrap around a shoulder from a dorsal to a ventral side of the body of a person using the rescue device 1b. The two shoulder strap sections 23, 24 extend on the ventral side up to two belt sliders 25, 26, which are set up to guide the body strap 12, through which the two shoulder strap sections 23, 24 lead into two chest strap sections 27, 28. The chest strap sections 27, 28 can be both connected to and detached from each other using a two-piece metallic buckle 29. The buckle 29 also has a belt slide 30 on each plug-in part of the buckle. The belt sliders 30 form a transition from the chest strap sections 27, 28 to the end sections 31, 32 of the body strap 12, which extend in pairs parallel to each other, that is, they are arranged one after the other in the top-down view shown in FIG. 2.

The end sections 31, 32 have an excess length, by which means the body strap 12 can be adjusted to different body sizes and shapes of a person using the rescue device 1a.

It is understood that the individual belt sections 17, 18, 23, 24 and 27, 28 may be of different lengths, depending on the body dimensions of the person using the rescue device 1a.

Reference is now made to FIG. 3, where identical or parts with the same effect are designated with the same reference numbers as in FIGS. 1 and 2 and the respective reference number is accompanied by the letter b.

A person 33 schematically shown in front view in FIG. 3A has attached a body strap 12b of a rescue device 1b, that is, their legs 34 are in leg loops 10b, 11b and the shoulder belt sections 23b, 24b are on the shoulders of the person 33.

By simultaneously pulling up two chest strap sections 27b, 28b and the parallel end sections 31b, 32b, which are gripped by the hands 35 of the person, in the direction of the arrows 36, the two leg straps 10b, 11b move in the proximal direction, that is, in the direction of the shoulders of the person 33. Thus, the length can be adjusted to their height until the position shown in FIG. 3A is reached, in which the leg straps 10b, 11b are tight to the legs, and the straps are on the shoulders of person 33.

During this movement, the one-piece body strap 12b is pulled through loops 37 in the leg straps 10b, 11b as well as belt sliders, not shown in FIG. 3A, labeled in FIG. 2 as 25 and 26. This reduces its effective length, i.e. the strap length that is wrapped around the body of the person 32 is shorter.

The position shown in FIG. 3A can be fixed by means of the belt sliders labeled in FIG. 2 as 25, 26.

A person 33 schematically shown in front view in FIGS. 3B and 3C has attached the body strap 12b of a rescue device 1b and has adjusted the length as shown in FIG. 3a. The adjustment of the body strap 12b to the girth of the person 33 is carried out in two steps. In a first step, two chest strap sections 27b, 28b and end sections 31b, 32b are moved towards each other on the ventral side medially in the direction of arrows 38 in such a way that a buckle 29b can be inserted.

In a second step shown in FIG. 3C, only the end sections 31b, 32b are pulled laterally in the direction of arrows 39, as a result of which the body strap 12b is adjusted in the circumferential direction to the body of the person 33 and the chest strap sections 27b, 28b are tight to the upper body of the person 33.

After the body strap 12b has been adjusted to the girth, the rescue device 1b is ready for use, that is, the body strap 12b is sufficiently tight to the body of the person 33, such that the person 33 cannot slip out of the rescue device 1b during a jump from a wind turbine, for example from a nacelle.

It is possible to fix the body strap 12b in the position shown in FIG. 3C using the belt slider 30b of the buckle 29b.

The belt sliders labeled in FIG. 2 as 25, 26 hold the body strap 12b, which has been adjusted to the height of the person to be rescued, in the position shown in FIG. 3A, while the belt sliders 30b of the buckle 29b hold a body strap adjusted to the person's girth in the position shown in FIG. 3C.

The invention creates a rescue device 1-1b, which can be adjusted to the body 33 of a person using the rescue device in only three steps:
1) Adjusting the length (arrows 36, FIG. 3a)
2) Inserting the buckle 29; 29b (arrows 38, FIG. 3b)
3) Adjusting the circumference (arrows 39, FIG. 3c)

It is understood that the rescue device 1-1b according to the invention is also suitable for a jump out of a hollow rotor blade of a wind turbine.

1. Rescue device (1-1b) for rescuing a person (33) from a wind turbine (5), which comprises a parachute and a harness (9; 9b), which can be or is connected to the parachute, and which can be donned by the person to be rescued (33), characterized in that
a static line (2) for connecting the rescue device (1-1b) to the wind turbine (5) is provided.

2. Rescue device according to claim 1,
characterized in that
the harness (9, 9b) comprises two leg straps (10, 11; 10b, 11b) and a preferably one-piece body strap (12; 12b), which can be connected to the two leg straps.

3. Rescue device according to claim 1,
characterized in that
the harness (9; 9b) comprises two leg straps (10, 11; 10b, 11b), each of which has a loop (37), through which the preferably one-piece body strap (12; 12b) is passed.

4. Rescue device according to claim 1,
characterized in that
the harness (9; 9b) can be adjusted to the body of the person to be rescued (33), in particular to their body shape and/or size.

5. Rescue device according to claim 1,
characterized in that
the harness (9; 9b) comprises two leg straps (10, 11; 10b, 11b), which can be moved in the proximal direction (36) to adjust the harness to the body of the person to be rescued (33), in particular their height.

6. Rescue device according to claim 1,
characterized in that
the harness (9; 9b) has a preferably one-piece body strap (12; 12b) with two body strap sections (27, 28; 27b, 28b), which intersect on a dorsal side.

7. Rescue device according to claim 1,
characterized in that
the harness (9; 9b) comprises a preferably one-piece body strap (12; 12b), which is connected to the parachute at the point of intersection of two body strap sections (27, 28; 27b, 28b) of the body strap (12; 12b), which intersect on a dorsal side.

8. Rescue device according to claim 1,
characterized in that
the harness (9; 9b) comprises a preferably one-piece body strap (12; 12b), the end sections of which (31, 32; 31b, 32b) can be moved to adjust the harness to the body of the person to be rescued (33), in particular their girth and their height, preferably in a direction which has a ventral and/or a lateral movement component.

9. Rescue device according to claim 1,
characterized in that
the harness (9; 9b) has a preferably one-piece body strap (12; 12b), which comprises a connecting means (29; 29b), through which the chest strap sections (27, 28; 27b, 28b) can be connected to and detached from each other.

10. Rescue device according to claim 1,
characterized in that
the parachute is packed such that it is airtight and/or impermeable to liquid, preferably vacuum-packed.

11. Rescue device according to claim 1,
characterized in that
the harness (9; 9b) and/or a packing bag (14), in which the parachute is located, is/are made of a fire-resistant or at least fire-retardant material.

12. Wind turbine (5), comprising a rescue device (1-1b) according to claim 1.

13. Wind turbine according to claim 12,
characterized in that
the nacelle (4) or a hollow rotor blade of the wind turbine has a means (7) which is designed for the attachment of a static line (2).

14. Wind turbine according to claim 13,
characterized in that
the attachment means (7) is placed in the area of an opening (3) of the nacelle (4) or of the rotor blade.

15. Use of a parachute, which is connected to a preferably one-piece body strap (12; 12b) and can be connected to a wind turbine (5) by means of a static line (2), for the emergency rescue of a person (33) from the wind turbine (5).
